(19) United States
(12) Patent Application Publication
(10) Pub. No.: US 2014/0233410 A1
(43) Pub. Date: Aug. 21, 2014

(54) RECEPTION QUALITY MEASUREMENT DEVICE AND RECEPTION QUALITY MEASUREMENT METHOD

(71) Applicants: FUJITSU LIMITED, Kawasaki-shi (JP); NTT DOCOMO, INC., Tokyo (JP); NEC Corporation, Tokyo (JP)

(72) Inventors: Satoshi MIKAMI, Kawasaki (JP); Ken Agatsuma, Sendai (JP); Junya Mikami, Kawasaki (JP); Kazuhiro Ishida, Tokyo (JP)

(73) Assignees: FUJITSU LIMITED, Kawasaki-shi (JP); NTT DOCOMO, INC., Tokyo (JP); NEC Corporation, Tokyo (JP)

(21) Appl. No.: 14/167,811

(22) Filed: Jan. 29, 2014

(30) Foreign Application Priority Data
Feb. 20, 2013 (JP) 2013-031241

(51) Int. Cl. H04W 24/10

(52) U.S. Cl. CPC H04W 24/10
USPC 370/252

(57) ABSTRACT

A reception quality measurement device includes a rate changing unit configured to downsample at least either a first sample sequence of a received signal with a first sampling rate or a second sample sequence of the received signal having a second sampling rate to adjust the sampling rates of the first sample sequence and the second sample sequence to a common sampling rate, and a power calculation unit configured to calculate a power intensity according to a cumulative total power of a predetermined number of samples included in either the first sample sequence or the second sample sequence with the common sampling rate.

### CROSS-REFERENCE TO RELATED APPLICATION

This application is based upon and claims the benefit of priority of the prior Japanese Patent Application No. 2013-031241, filed on Feb. 20, 2013, the entire contents of which are incorporated herein by reference.

### FIELD

The embodiments discussed herein relate to a reception quality measurement in a mobile station device.

### BACKGROUND

A 3G (3rd Generation) mobile communication system employing a W-CDMA (Wideband Code Division Multiple Access) technique meets market demands by introducing HSDPA (High Speed Downlink Packet Access) and therefore has ensured a competitive edge over other systems. However, to response to multimedia traffic and a ubiquitous traffic rapidly expanding, technical evolution may be necessary in the long run.

Therefore, wireless communication systems specified as LTE (Long Term Evolution), E-UTRA (Evolved Universal Terrestrial Radio Access), E-UTRAN (Evolved Universal Terrestrial Radio Access Network), and the like have begun to be widely used. LTE, E-UTRA, and E-UTRAN are communication systems specified by the standards of the 3GPP (3rd Generation Partnership Project) that is a standards body. The delay in LTE is reduced from about 10 ms to at most 5 ms, compared with 3G, and the throughput therein increases 2 to 4 times, compared with HSDPA, resulting in enhancement of frequency usage efficiency.

In the 3G mobile communication system, the LTE mobile communication system, and the like, a mobile station device measures reception quality of a wireless signal. Examples of the reception quality measured in the mobile station device include RSRP (Reference Signal Received Power) and RSRQ (Reference Signal Received Quality). RSRP and RSRQ are used, for example, at the time of cell reselection as described below.

As an example, an operation of cell reselection of LTE in 3GPP Release 9 will be described below. First, a case of transition to 3G UMTS (Universal Mobile Telecommunications System) while the mobile station device is located in an LTE cell will be described below. 3GPP Release 9 specifies that, when threshServingLowQ is set in System Information Block 3 transmitted from the LTE cell, an operation determination by a threshold determination of RSRQ (Reference Signal Received Quality) is executed. On the other hand, 3GPP Release 9 specifies that, when no threshServingLowQ is set, an operation determination by a threshold determination of RSRP (Reference Signal Received Power) is executed.

Further, 3GPP Release 9 specifies that, in the case of transition to LTE while the mobile station device is located in a UMTS cell, when both Threshx high 2 and Threshx low 2 are set in System Information Block 19 of the UMTS cell, an operation determination by a threshold determination of RSRQ is executed. On the other hand, 3GPP Release 9 specifies that, when either of Threshx high 2 and Threshx low 2 is not set, an operation determination by a threshold determination of RSRP is executed. In this manner, in the operation of cell reselection in 3GPP Release 9, an operation determination is executed based on a threshold of RSRP or RSRQ.

As a related technique, WO 2009/057481 pamphlet, for example, discloses user equipment for measuring a signal power of a neighboring cell in a predetermined bandwidth. The user equipment includes a measurement bandwidth management unit for determining a measurement bandwidth in accordance with a measurement pattern where the measurement bandwidth varies with the measurement time, a measurement unit for measuring signal power instantaneous values of a neighboring cell in the determined measurement bandwidth, and an averaging unit for calculating a signal power of the neighboring cell by averaging the measured signal power instantaneous values.

For example, Japanese Laid-open Patent Publication No. 2009-60601 discloses a receiver configured to receive wireless signals. The receiver includes a measurement circuit configured to measure reception quality of a wireless signal received by the receiver, a determination circuit configured to determine a first frequency bandwidth, and a controller configured to control the measurement circuit so that a first reception quality is determined using the first frequency bandwidth determined by the determination circuit. Further, the determination circuit is configured to determine a second frequency bandwidth. When the first reception quality satisfies a first reception quality criterion, the controller controls the measurement circuit so that a second reception quality is determined by executing a second measurement using the second frequency bandwidth, which is determined by the determination circuit and is larger than the first frequency bandwidth.

For example, Japanese Laid-open Patent Publication No. 2011-155592 discloses a mobile station including a measurement unit configured to measure radio quality of a serving cell and a peripheral cell. The measurement unit adjusts a combination of a measurement bandwidth and a measurement section in accordance with a measurement result of the radio quality.

For example, Japanese Laid-open Patent Publication No. 2011-61728 discloses that any one of a first frequency band and a second frequency band that are part of a band used for communications with a terminal is set as a specific frequency band serving as a measurement subject of reception quality.

As a related technique, for example, WO 2009/057520 discloses user equipment for measuring a signal power of a neighboring cell. The user equipment includes a moving speed estimation unit for estimating a moving speed of the device or a fading frequency of a propagation channel, a measurement bandwidth management unit for determining a measurement bandwidth in accordance with the moving speed or the fading frequency of the propagation channel, and a measurement unit for measuring a signal power of a neighboring cell in the determined measurement bandwidth.

### SUMMARY

According to one aspect of the embodiments, a reception quality measurement device is provided. The reception quality measurement device includes a rate changing unit configured to downsample at least either a first sample sequence of a received signal with a first sampling rate or a second sample sequence of the received signal having a second sampling rate to adjust sampling rates of the first sample sequence and the second sample sequence to a common sampling rate and a power calculation unit configured to calculate a power intensity according to a cumulative total of powers of a predetermined number of samples included in either the first sample sequence or the second sample sequence with the common sampling rate.

The object and advantages of the embodiments will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A and FIG. 1B are illustrative diagrams of examples of a reception quality measurement;

FIG. 2A and FIG. 2B are illustrative diagrams of other examples of the reception quality measurement;

FIG. 3 is a table illustrating a relationship among system frequency bandwidth, the number of FFT points, and effective subcarriers;

FIG. 4 is a hardware configuration diagram of one example of a mobile station device;

FIG. 5 is an illustrative diagram of one example of a function configuration of a search unit;

FIG. 6 is an illustrative diagram of one example of a function configuration of RSSI (Received Signal Strength Indicator) calculation unit;

FIG. 7 is an illustrative diagram of a signal format of reception IQ data input to a rate changing unit;

FIG. 8 is an illustrative flowchart of a reception quality measurement operation in the search unit; and

FIG. 9 is a correspondence table of system frequency bandwidth and the number of resource blocks.

### DESCRIPTION OF THE EMBODIMENTS

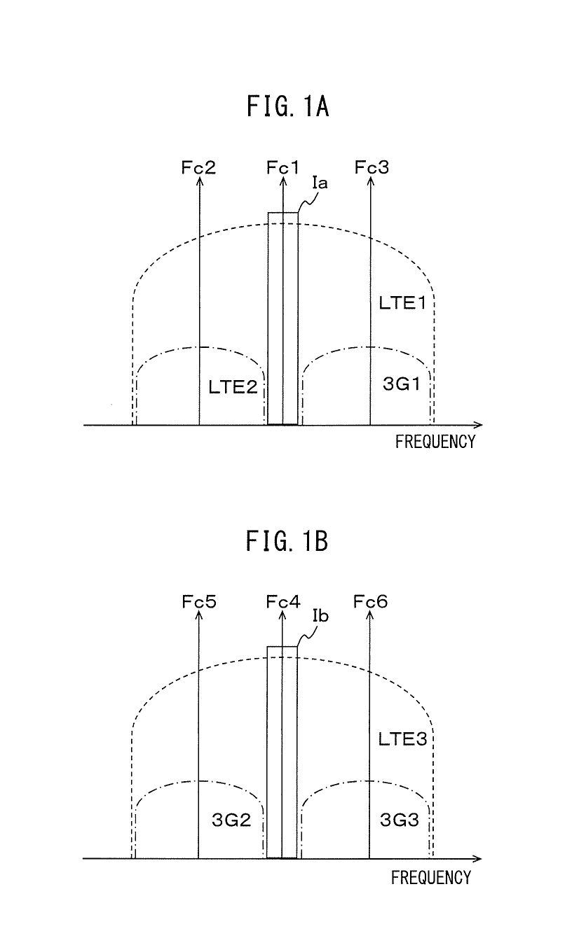

The frequency bands of a plurality of cells having a possibility of interference may be overlapped with each other, depending on the frequency operations by a telecommunications carrier of mobile communication systems. For example, the frequency band of a certain LTE cell may be overlapped with the frequency band of another LTE cell or a 3G cell. FIG. 1A and FIG. 1B illustrate one example of reception quality measurement.

FIG. 1A illustrates an example where the frequency band of LTE2 that is an LTE cell having a bandwidth of 5 MHz and the frequency band of 3G1 that is a 3G cell having a bandwidth of 5 MHz are overlapped with the frequency band of LTE1 that is an LTE cell having a bandwidth of 10 MHz. The dashed line represents the frequency band of LTE1 and the dashed-dotted lines represent the frequency bands of LTE2 and 3G1.

Further, FIG. 1B illustrates an example where the frequency bands of 3G2 and 3G3 that are 3G cells each having a bandwidth of 5 MHz are overlapped with the frequency band of LTE3 that is an LTE cell having a bandwidth of 10 MHz. The dashed line represents the frequency band of LTE3 and the dashed-dotted lines represent the frequency bands of 3G2 and 3G3.

When reception quality measurement processing of LTE is executed, under 3GPP TS 36.133 that is a standard of 3GPP, a measurement needs only to be made in a bandwidth of 1.4 MHz and no measurement is necessary in the entire bandwidth of a cell in which user equipment exists. A measurement in a bandwidth of 1.4 MHz makes it possible to decrease circuit size and current consumption.

However, in a center frequency portion Fc1 of the 10 MHz band of the bandwidth of LTE1 illustrated in FIG. 1A, there is a region where the frequencies of LTE2 and 3G1 each having a bandwidth of 5 MHz are not overlapped with each other. Further, in a center frequency portion Fc4 of the 10 MHz band of the bandwidth of LTE3 illustrated in FIG. 1B, there is a region where the frequencies of 3G2 and 3G3 each having a bandwidth of 5 MHz are not overlapped with each other.

In these cases, when a measurement is made in the 1.4 MHz bandwidth within the center frequency portions Fc1 and Fc4 illustrated by being surrounded by the solid lines Ia and Ib, respectively, a band where no frequencies are overlapped is measured. As a result, an inappropriate measurement of RSRQ may cause the following cases.

Case 1: Upon a handover from an LTE cell of a 10 MHz bandwidth to an LTE cell or a 3G cell of a 5 MHz bandwidth, RSRQ of a serving cell is not measured appropriately.

Case 2: Upon a handover from an LTE cell of a 5 MHz bandwidth to an LTE cell of a 10 MHz bandwidth, RSRQ of a peripheral cell is not measured appropriately.

Case 3: Upon a handover from a 3G cell of a 5 MHz bandwidth to an LTE cell of a 10 MHz bandwidth, RSRQ of a peripheral cell is not measured appropriately.

Further, in the aforementioned examples, the bandwidths of LTE1 and LTE3 are 10 MHz. However, also when the bandwidths of LTE1 and LTE3 are 15 MHz or 20 MHz, the same problems occur, depending on a bandwidth combination with LTE2, 3G1, 3G2, and 3G3 having a bandwidth of 5 MHz.

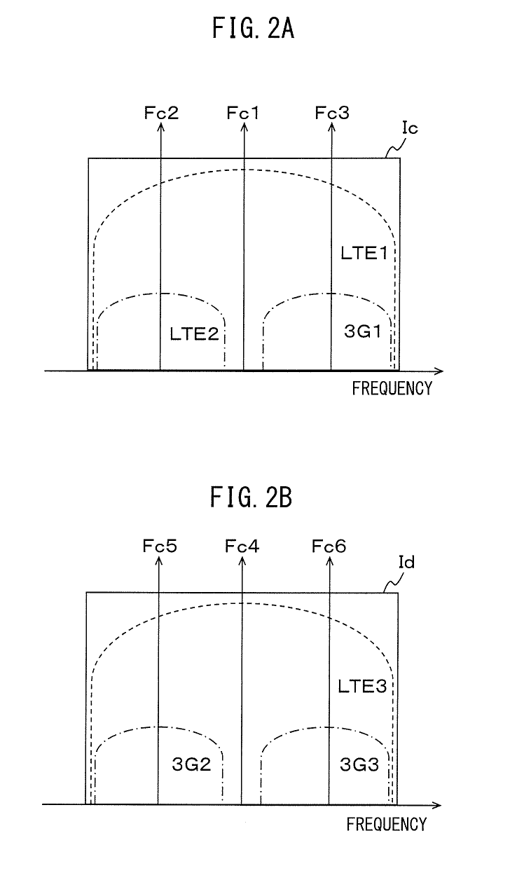

FIG. 2A and FIG. 2B are illustrative diagrams of other examples of reception quality measurement. In FIG. 2A, in the entire band of LTE1 of a 10 MHz band illustrated by being surrounded by the solid line Ic, reception quality measurements are made and measurement results in the entire band are averaged. In this case, even when a region where the frequency of LTE1 and the frequencies of LTE2 and 3G1 are not overlapped with each other exists, a reception quality measurement may be made with consideration of a band where interference occurs by overlapping of the frequency of LTE1 and the frequencies of LTE2 and 3G1.

In the same manner, in FIG. 2B, in the entire band of LTE3 of a 10 MHz band illustrated by being surrounded by the solid line Id, reception quality measurements are made, and measurement results in the entire band are averaged. In this case, even when a region where the frequency of LTE3 and the frequencies of 3G2 and 3G3 are not overlapped with each other exists, a reception quality measurement may be made with consideration of a band where interference occurs by overlapping of the frequency of LTE3 and the frequencies of 3G2 and 3G3.

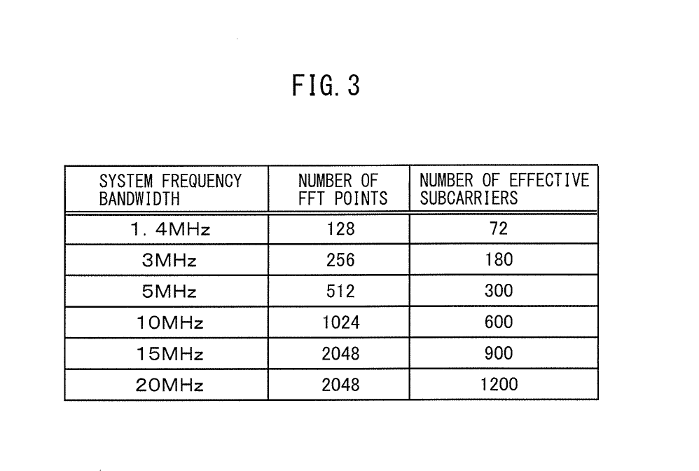

However, when the entire bandwidth is measured, with an increase in system frequency bandwidth to 10 MHz, 15 MHz, and 20 MHz, circuit size/current consumption is increased. FIG. 3 is a table illustrating the relationship among system frequency bandwidth, the number of points of FFT (Fast Fourier Transform) processing applied to a received signal, and effective subcarriers. As the system frequency bandwidth increases, the number of FFT points and the number of effective subcarriers for reception quality measurement processing increase. As a result, an increase in data amount to be processed causes an increase in power consumption and circuit size.

<Configuration of Mobile Station Device>

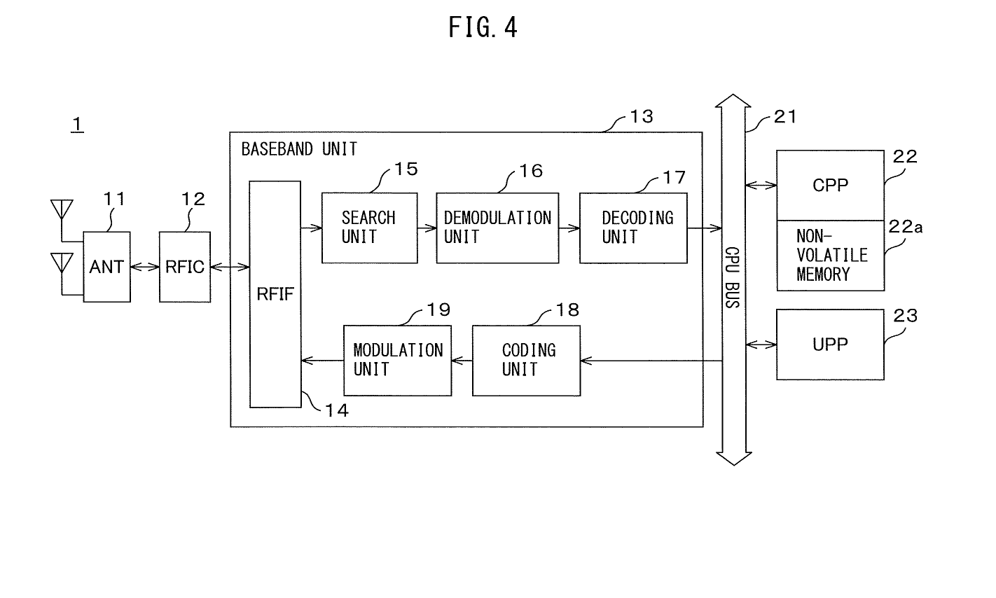

FIG. 4 illustrates a hardware configuration diagram of one example of a mobile station device. The following description uses an example in which a mobile station device 1 is a mobile station device conforming to LTE. However, in the example, the mobile station device described in the present specification is not intended to be exclusively adopted only as the mobile station device conforming to LTE. The mobile station device described in the present specification is widely employable in mobile station devices which measures reception quality.

The mobile station device 1 includes an antenna (ANT) 11, an RFIC (Radio Frequency Integrated Circuit) 12, a baseband unit 13, a CPP (C-plane Processor) 22, and a UPP (U-plane Processor) 23. The baseband unit 13 includes an RFIF (Radio Frequency Interface) 14, a search unit 15, a demodulation unit 16, a decoding unit 17, a coding unit 18, and a modulation unit 19.

Note that, the hardware configuration of FIG. 4 is merely an example to describe the embodiments. Any other hardware configuration is employable for the mobile station device described in the present specification as long as the mobile station device executes the following operations. Further, in some cases, the mobile station device is referred to as a “mobile station” in the following description.

The antenna 11 is mounted in the mobile station 1 to receive and transmit wireless signals. The RFIC 12 upconverts a baseband signal to be transmitted to a radio frequency signal and feeds the resulting signal to the antenna 11, and downconverts a radio frequency signal received in the antenna 11 to a baseband signal and feeds the resulting signal to the RFIF 14 of the baseband unit 13.

The baseband unit 13 is possibly an LSI (Large Scale Integration) such as an FPGA (Field-Programming Gate Array), and an ASIC (Application Specific Integrated Circuit). Further, the baseband unit 13 is possibly a processor operated in accordance with a predetermined program. The RFIF 14 mediates between the RFIC 12 and a RAT (Radio Access Technology) such as an LTE system, 3G and GSM (a registered trademark) (Global System for Mobile communications).

The search unit 15 inside the baseband unit 13 receives reception IQ data. The reception IQ data includes in-phase component data and quadrature phase component data generated by converting a reception baseband signal into a digital format. The search unit 15 executes search processing of each of band search, cell search, and path search based on the reception IQ data and detects the head timing of a cell to execute FFT processing. The search unit 15 calculates RSRP, RSSI, and RSRQ.

The demodulation unit 16 executes channel estimation processing and demodulation processing using an FFT processing result fed from the search unit 15. The demodulation unit 16 executes decoding processing of a PCFICH (Physical Control Format Indicator CHannel) and a PHICH (Physical Hybrid Automatic Repeat Request Indicator CHannel). The demodulation unit 16 executes decoding processing of a PDCCH (Physical Downlink Control CHannel) and a PBCH (Physical Broadcast CHannel). The demodulation unit 16 performs a propagation channel environment measurement such as CQI generation.

The decoding unit 17 executes derate matching processing of a demodulated PDSCH (Physical Downlink Shared CHannel) and executes processing from turbo decoding to CRC (Cyclic Redundancy Check). The decoding unit 17 executes HARQ (Hybrid Automatic Repeat reQuest) synthesis processing for a retransmission PDSCH prior to turbo coding. Data decoded in the decoding unit 17 is fed to the CPP 22 and the UPP 23 through a CPU bus 21.

The CPP 22 mainly executes Layer 3 protocol processing and reception quality measurement control processing. The CPP 22 is established together with a non-volatile memory 22a used in the reception quality measurement control processing. The UPP 23 mainly executes Layer 2 protocol processing.

The coding unit 18 executes CRC code addition, turbo coding, rate matching processing, and scramble processing with respect to a UL-SCH (UpLink-Shared CHannel) fed from the UPP 23. Further, the unit executes CRC code addition, tail biting convolutional coding, Reed-Muller coding, rate matching processing, and scramble processing with respect to channel quality information and control information such as retransmission control information.

The modulation unit 19 executes modulation processing, DFT (Discrete Fourier Transform) processing, and IFFT (Inverse FFT) processing with respect to a coded UL-SCH and an accompanying control channel. Further, the modulation unit 19 executes preamble generation, DFT processing, and IDFT (Inverse DFT) processing in RACH (Random Access CHannel) transmission. The modulation unit 19 performs timing control in transmission control based on timing advance information.

<Configuration of Search Unit 15>

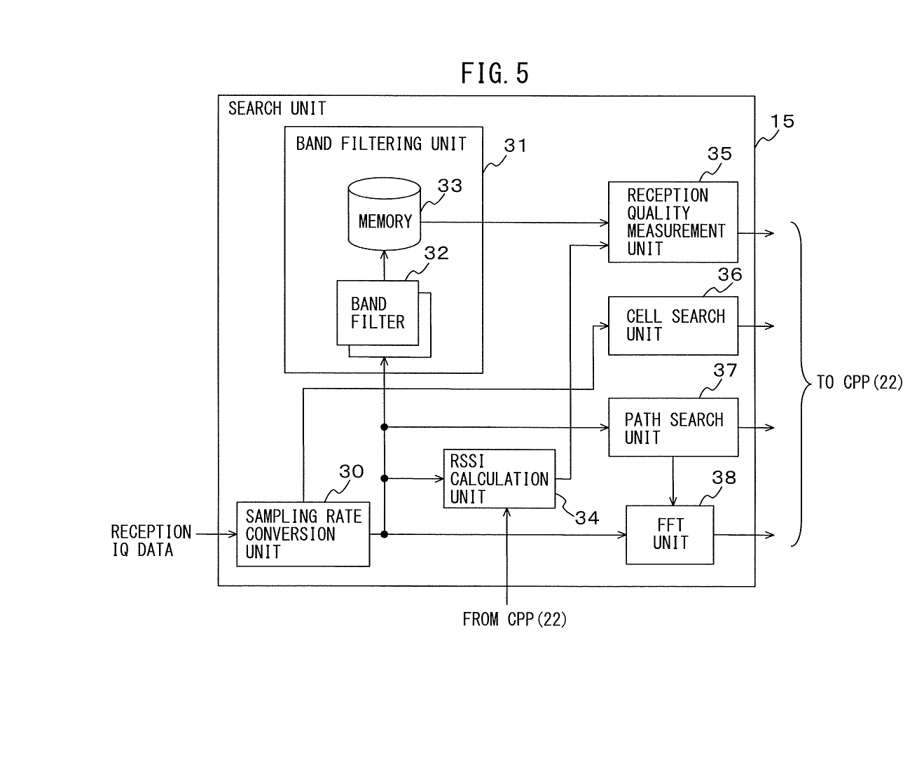

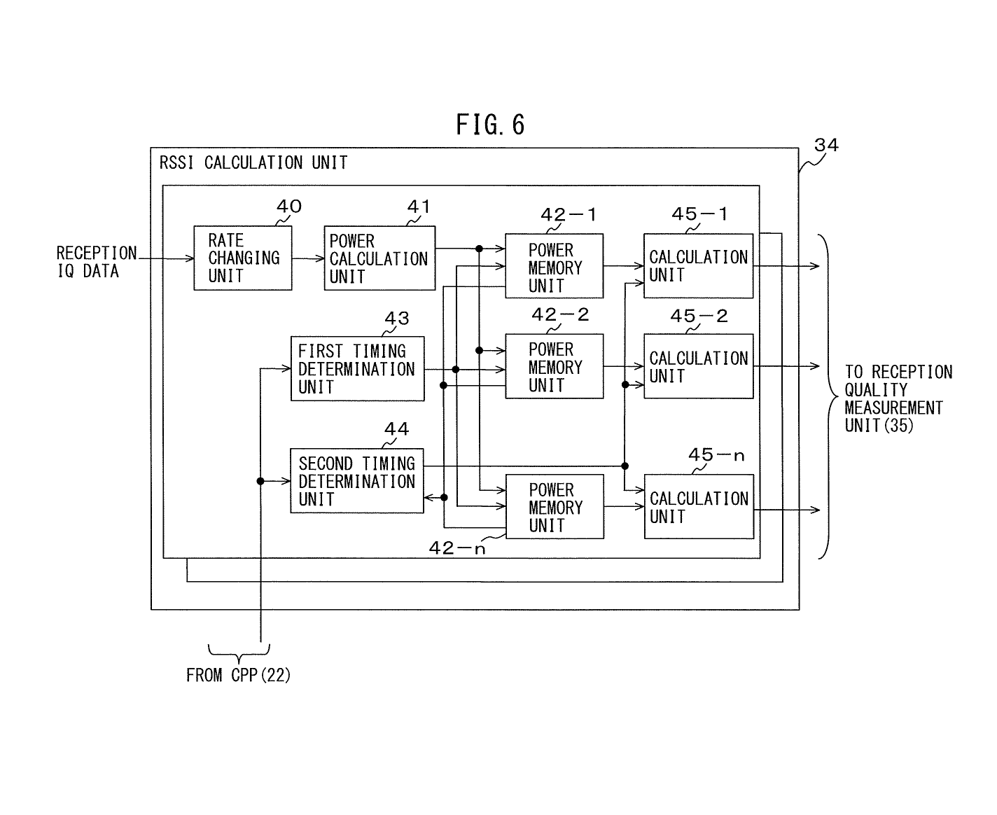

FIG. 5 is an illustrative diagram of one example of a function configuration of the search unit 15. The search unit 15 includes a sampling rate conversion unit 30, a band filtering unit 31, an RSSI calculation unit 34, a reception quality measurement unit 35, a cell search unit 36, a path search unit 37, and an FFT unit 38. Note that the function configuration diagram of FIG. 5 mainly illustrates a configuration relevant to the functions described in the present specification. The search unit 15 may include other elements other than the illustrated elements. The illustrative diagram of the function configuration of FIG. 6 is considered in the same manner.

The sampling rate conversion unit 30 converts the reception IQ data sampled at a sampling rate RA in an analog-digital conversion circuit inside the RFIF 14 into a signal of a sampling rate RB which is based on a processing speed inside the baseband unit 13. The sampling rate conversion unit 30 may perform amplitude correction of the reception IQ data as preprocessing with respect to the conversion processing from the sampling rate RA to the sampling rate RB.

The sampling rate RA varies with system frequency bandwidth. When the system frequency bandwidth is 1.4, 3, 5, 10, 15, and 20 MHz, the sampling rate RA is, for example, 1.92, 3.84, 7.68, 15.36, 23.04, and 30.72 MHz, respectively. On the other hand, the sampling rate RB may be 30.72 MHz (30.72×10⁶ samples/second) that is a fixed value. The reception IQ data with the sampling rate RB after conversion is fed to the band filtering unit 31, the RSSI calculation unit 34, the cell search unit 36, the path search unit 37, and the FFT unit 38.

The band filtering unit 31 includes a band filter 32 and a memory 33. The band filter 32 performs filtering to allow a received signal of a cell to be measured to pass in a 1.4 MHz band from a center frequency thereof. Information passed through the band filter 32 by the filtering is used in an RSRP measurement. Further, the band filtering unit 31 may include an independent band filter 32 for each reception antenna branch. For example, when N reception antenna branches are employed, the band filtering unit 31 may include band filters 32 totaling N circuits.

The memory 33 stores an output signal of the band filter 32. The memory 33 may have a memory capacity for storing symbols having a number obtained by adding, for example, the number of symbol 1 of Extended CP (Extended Cyclic Prefix) to the number of OFDM (Orthogonal Frequency Division Multiplexing) symbols transmitted for 5 ms. Thereafter, the output signal of the band filter 32 stored in the memory 33 is fed to the reception quality measurement unit 35.

The RSSI calculation unit 34 calculates RSSI in the entire frequency band of the system frequency band. The RSSI calculation unit 34 transmits an RSSI calculation result to the reception quality measurement unit 35.

The reception quality measurement unit 35 measures RSRP with respect to the cell to be measured from the output signal of the band filter 32. The reception quality measurement unit 35 calculates RSRQ based on the measured RSRP and the RSSI calculated by the RSSI calculation unit 34. The reception quality measurement unit 35 transmits the RSSI, RSRP, and RSRQ to the CPP 22 as the reception quality measurement results.

The cell search unit 36 executes processing of band search, AFC (Automatic Frequency Control), initial cell search, and peripheral cell search and transmits level information, an AFC deviation, a cell ID, timing information, and the like to the CPP 22.

The path search unit 37 averages the reception IQ data and performs peak detection, performs path search in a cell where the mobile station 1 is located and a peripheral cell, and detects a wireless frame head in each cell as a path timing. The path search unit 37 transmits a timing signal of the path timing to the FFT unit 38 and the CPP 22.

The FFT unit 38 executes FFT processing of a baseband signal based on the detection result of the wireless frame head by the path search unit 37 and transmits symbol data and an FFT timing as processing results to the CPP 22.

FIG. 6 is an illustrative diagram of one example of a function configuration of the RSSI calculation unit 34. The RSSI calculation unit 34 includes, individually for each reception antenna branch, a rate changing unit 40, a power calculation unit 41, power memory units 42-1 to 42-n, a first timing determination unit 43, a second timing determination unit 44, and calculation units 45-1 to 45-n.

The RSSI calculation unit 34 includes the power memory units 42-1 to 42-n and the calculation units 45-1 to 45-n individually for each of n cells to be measured. In some cases, the power memory units 42-1 to 42-n are collectively referred to as a “power memory unit 42”. In some cases, the calculation units 45-1 to 45-n are collectively referred to as a “calculation unit 45”.

The rate changing unit 40 downsamples the reception IQ data with the sampling rate RB, so that the sampling rate of the reception IQ data is a sampling rate RC lower than the sampling rate RB. For example, the sampling rate RC may be 1.92 MHz corresponding to a system frequency bandwidth of 1.4 MHz. Hereinafter, in some cases, the sampling period of data with the sampling rate RC is referred to as Ts.

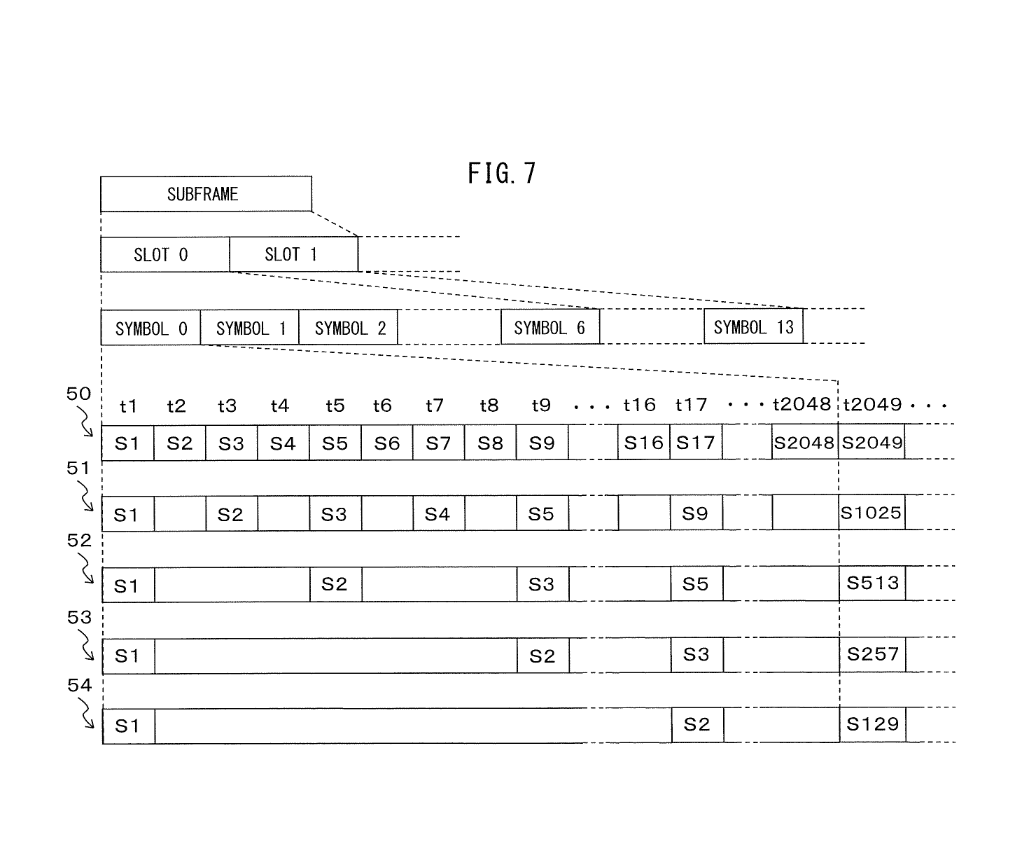

FIG. 7 is an illustrative diagram of a signal format of the reception IQ data of the sampling rate RB input to the rate changing unit 40. One subframe includes two slots and one slot includes seven OFDM symbols.

Reference numeral 50 represents reception IQ data when the system frequency bandwidth is 15 MHz or 20 MHz. Samples at times t1 to t2049 are S1 to S2049, respectively, and one symbol period includes 2048 samples S1 to S2048. When the sampling rate RA prior to conversion by the sampling rate conversion unit 30 is 30.72 MHz, the rate changing unit 40 may extract samples S1, S17, . . . of times t1, t17, . . . in a 16 sample period from the reception IQ data represented by reference numeral 50 and may discard other samples to downsample the reception IQ data with the sampling rate RB, to data having a sampling rate of 1.92 MHz.

Reference numeral 51 represents reception IQ data when the system frequency bandwidth is 10 MHz. Samples at times t1, t3, t5, t7, t9, tll, t13, t15, and t17 are S1 to S9, respectively, and one symbol period includes 1024 samples S1 to S1024. For example, when the sampling rate RA prior to conversion by the sampling rate conversion unit 30 is 15.36 MHz, the rate changing unit 40 may extract samples S1, S9, . . . of times t1, t17, . . . in an 8 sample period from the reception IQ data represented by reference numeral 51 and may discard other samples to downsample the reception IQ data with the sampling rate RB to data having a sampling rate of 1.92 MHz.

Reference numeral 52 represents reception IQ data when the system frequency bandwidth is 5 MHz. Samples at times t1, t5, t9, t13, and t17 are S1 to S5, respectively, and one symbol period includes 512 samples S1 to S512. For example, when the sampling rate RA prior to conversion by the sampling rate conversion unit 30 is 7.68 MHz, the rate changing unit 40 may extract samples S1, S5, . . . of times t1, t17, . . . in a 4 sample period from the reception IQ data represented by reference numeral 52 and may discard other samples to downsample the reception IQ data with the sampling rate RB to data having a sampling rate of 1.92 MHz.

Reference numeral 53 represents reception IQ data when the system frequency bandwidth is 3 MHz. Samples at times t1, t9, and t17 are S1 to S3, respectively, and one symbol period includes 256 samples S1 to S256. For example, when the sampling rate RA prior to conversion by the sampling rate conversion unit 30 is 3.84 MHz, the rate changing unit 40 may extract samples S1, S3, . . . of times t1, t17, . . . in a 2 sample period from the reception IQ data represented by reference numeral 53 and may discard other samples to downsample the reception IQ data with the sampling rate RB to data having a sampling rate of 1.92 MHz.

Reference numeral 54 represents reception IQ data when the system frequency bandwidth is 1.4 MHz. Samples at times t1 and t17 are S1 and S2, respectively, and one symbol period includes 128 samples S1 to S128. For example, when the sampling rate RA prior to conversion by the sampling rate conversion unit 30 is 1.92 MHz, the rate changing unit 40 may extract samples S1, S2, . . . of times t1, t17, . . . with respect to each sample from the reception IQ data represented by reference numeral 54 to downsample the reception IQ data with the sampling rate RB to data having a sampling rate of 1.92 MHz.

The power calculation unit 41 calculates an IQ power-addition value P_{BB} of the reception IQ data. The power calculation unit 41 calculates the IQ power-addition value P_{BB} in a cell to be measured c, a reception antenna a, a slot n, and an OFDM symbol t, based on the following expression (1).

$$\text{?} ( c , a , n , \text{?} ) = \text{?} {\vert {r}^{′} ( a , n , t , k ) \vert}^{2} \\ \text{?} \text{indicates text missing or illegible when filed} \qquad ( 1 )$$

The term r′(a, n, t, k) represents a sample value of the reception IQ data with the sampling rate RC after downsampling by the rate changing unit 40 and t represents a symbol number of any OFDM symbol including an RS (Reference Signal). TIM(c) represents an index value (RS start position) of a start sample of the RS determined from a path timing PT(c), a CP length CPLEN(c), and a subframe format SF(c) of a cell to be measured c. For example, when the sampling rate RC after downsampling by the rate changing unit 40 is 1.92 MHz, an RSSILEN value may be “128”. Further, as the RSSILEN value, a value where the maximum variation width (for example, equivalent to ±8 samples) of the path timing is taken into account may be used. For example, a value of 112 obtained by subtracting the number of samples (for example, 16=8 samples×2) corresponding to the maximum variation value from OFDM symbol 128 samples with a 1.92 MHz rate may be used as the RSSILEN value.

However, at the time when the power calculation unit 41 calculates the IQ power-addition value P_{BB}, the path timing PT(c) has not yet been detected in some cases. Therefore, the power calculation unit 41 may output a moving cumulative total of IQ powers of the following expression (2) as a candidate P_{BBC} of the IQ power-addition value at each sampling timing of the sampling rate RC. TIMO represents the position of each sample. In other words, since downsampling by the rate changing unit 40 reduces the sample number within one symbol compared with the case of the sampling rate RB, the cost (calculation amount and the like) relevant to calculation exemplified in expression (2) may be reduced and therefore an increase in circuit size and wasteful power consumption may be effectively suppressed.

$${P}_{BBC} ( c , a , n , t ) = \text{?} {\vert {r}^{′} ( a , n , t , k ) \vert}^{2} \\ \text{?} \text{indicates text missing or illegible when filed} \qquad ( 2 )$$

The candidate P_{BBC} output by the power calculation unit 41 is stored in the power memory unit 42. When each path timing in a cell to be measured has been detected, each of an OFDM symbol position t including the RS and the IQ power-addition value P_{BB} calculated with respect to a TIM(c) determined in accordance with the path timing PT(c) is extracted from the power memory unit 42.

The first timing determination unit 43 receives a timing signal of the path timing in the cell to be measured from the CPP 22. The first timing determination unit 43 determines a timing for storing the candidate P_{BBC} in the power memory unit 42 based on the path timing detected in the past.

For example, the first timing determination unit 43 determines a reference timing tc0 of a storage timing of the candidate P_{BBC}, based on the path timing PT detected during the last path search or cell search. The first timing determination unit 43 determines an RS start time (RS start position) RT for a case in which when the path timing is PT. When the number of frames from a wireless frame where the path timing PT has been detected to a current wireless frame is designated as FN and a wireless frame period is designated as TF, the reference timing tc0 may be calculated by the expression: tc0=RT+FN×TF.

The first timing determination unit 43 determines each of times tc0+j×Ts (variable j is an integer from −Δv to Δv) as the storage timing of the candidate P_{BBC}. The period Ts is a sampling period of the reception IQ data with the sampling rate RC. A reason why the IQ power-addition value is stored in a range of Δv×Ts before and after the storage timing tc0 is to take a possibility, that an actual path timing varies in a width between (×Δv×Ts) and (Δv×Ts) from the path timing tc0 predicted from the past path timing, into consideration.

Therefore, the times tc0+j×Ts correspond to a plurality of candidates of the path timing and Δv corresponds to an allowable variation width of the path timing. The storage timing may be determined by the CPP 22 and fed to the power memory unit 42 or may be calculated by the power memory unit 42 based on a timing signal.

The second timing determination unit 44 receives a timing signal of the path timing from the CPP 22, followed by reading the IQ power-addition value P_{BB} calculated with respect to a TIM(c) determined in accordance with a path timing PT(c) from the power memory unit 42 and then outputs the value P_{BB} to the calculation unit 45. The calculation unit 45 calculates RSSI by dividing the IQ power-addition value P_{BB} by an RSSILEN and outputs an average value of RRSIs over a predetermined number of slots to the reception quality measurement unit 35.

When the mobile station 1 is operated by an LTE-TDD (Time Division Duplex) system, the RSSI calculation unit 34 may calculate RSSI in a period allocated to a DL in a UL-DL configuration and a special subframe configuration.

In a modified example, the power calculation values of symbols accumulated when the power calculation unit 41 calculates the IQ power-addition value P_{BB}, may be reduced according to the allowable variation width Δv of the path timing. For example, the power calculation unit 41 calculates the IQ power-addition value P_{BB} based on the following expression (3).

$${P}_{BB} ( c , a , n , t ) = \text{?} {\vert {r}^{′} ( a , n , t , k ) \vert}^{2} \\ \text{?} \text{indicates text missing or illegible when filed} \qquad ( 3 )$$

The IQ power-addition value P_{BB} according to the expression (3) is not affected even when the path timing varies in a width between (−Δv×Ts) and (Δv×Ts). Therefore, in the present modified example, storage of (2Δv+1) candidates P_{BBC} of the IQ power-addition value may be omitted.

<Flowchart of Reception Quality Measurement Control>

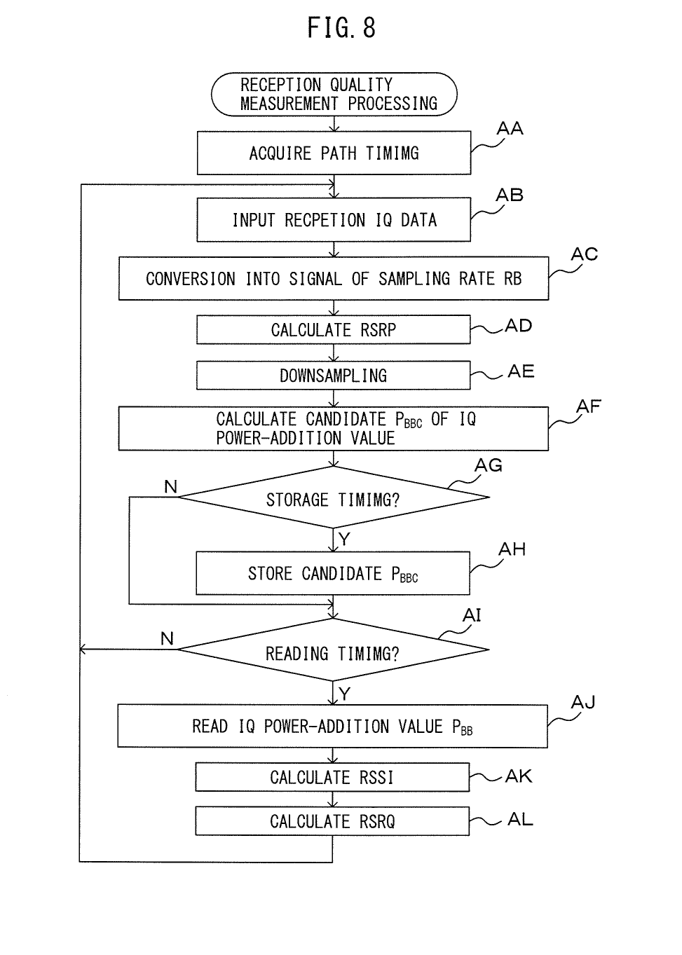

FIG. 8 is an illustrative flowchart of a reception quality measurement operation in the search unit 15. Further, a series of operations to be described with reference to FIG. 8 may be interpreted as a method including a plurality of steps. In this case, “operation” may be read as “step”. In operation AA, the path search unit 37 detects a path timing PT when a cell search operation or a path search operation is performed at a certain time. The path search unit 37 outputs the path timing PT to the CPP 22. The first timing determination unit 43 of the RSSI calculation unit 34 acquires the path timing PT from the CPP 22.

The path search unit 37 outputs a path timing detected in every path search operation to the CPP 22. The second timing determination unit 44 acquires the path timing PT from the CPP 22.

In operation AB, the search unit 15 inputs the reception IQ data. In operation AC, the sampling rate conversion unit 30 converts the reception IQ data to a signal with the sampling rate RB. In operation AD, the reception quality measurement unit 35 measures RSRP with respect to a cell to be measured.

In operation AE, the rate changing unit 40 downsamples the reception IQ data and then changes the sampling rate of the reception IQ data to the sampling rate RC smaller than the sampling rate RB. In operation AF, the power calculation unit 41 calculates a candidate P_{BBC} of an IQ power-addition value in each sampling period Ts.

In operation AG, the first timing determination unit 43 determines whether a timing for storing the candidate P_{BBC} in the power memory unit 42 has come based on the path timing PT. When the storage timing has come (operation AG: Y), the operation proceeds to operation AH. When the storage timing has not come (operation AG: N), the operation proceeds to operation AI.

In operation AH, the first timing determination unit 43 stores the candidate P_{BBC} in the power memory unit 42. Thereafter, the operation proceeds to operation AI. In operation AI, the second timing determination unit 44 determines whether a read timing of a power-addition value P_{BB} has come in accordance with a path timing received from the CPP 22. When the read timing has come (operation AI: Y), the operation proceeds to operation AJ. When the read timing has not come (operation AI: N), the operation returns to operation AB.

In operation AJ, the second timing determination unit 44 reads the power-addition value P_{BB} from the power memory unit 42 and then outputs the read value to the calculation unit 45. In operation AK, the calculation unit 45 calculates RSSI. In operation AL, the reception quality measurement unit 35 calculates RSRQ based on the measured RSRP and the RSSI calculated by the RSSI calculation unit 34. For example, the reception quality measurement unit 35 may calculate the RSRQ according to the following expression (4).

RSRQ=RSRP+10 log(the number of RB)−RSSI (4)

The number of RB in expression (4) represents the number of resource blocks according to a bandwidth where RSSI is measured. The number of RB may be the number of resource blocks according to a system frequency bandwidth corresponding to the sampling rate RC after downsampling performed by the rate changing unit 40.

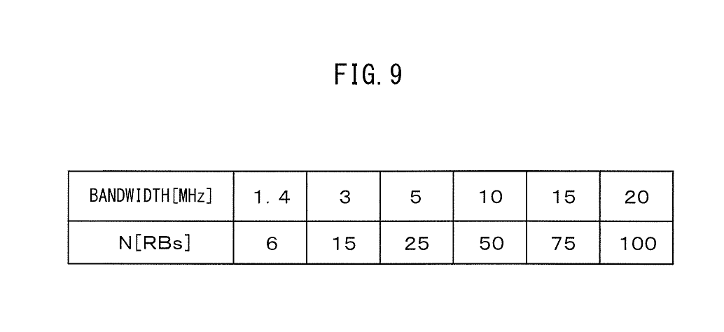

FIG. 9 is a correspondence table of the system frequency bandwidth and the number of resource blocks. When the sampling rate RC after downsampling is 1.92 MHz, the number of resource blocks may be 6 corresponding to a system frequency bandwidth of 1.4 GHz.

The reception quality measurement unit 35 transmits the RSSI, RSRP, and RSRQ to the CPP 22 as reception quality measurement results. Thereafter, the operation returns to operation AB.

According to the device or the method disclosed in the present specification, reception quality of a cell to be measured may be measured with low power consumption and high accuracy.

The present embodiment makes it possible to measure RSRQ based on RSSIs measured over the entire bandwidth of the system frequency band of the mobile station device 1. Therefore, even when there is a region where frequencies are not overlapped among the system frequency bands of a plurality of cells having a possibility of interference, it is possible to measure reception quality with consideration of the interference of an overlapping portion of these system frequency bands. Further, according to the present embodiment, since the RSSI is measured using downsampled IQ reception data, the calculation size at the time of measurement in the entire bandwidth is reduced and also circuit size/power consumption is reduced.

In addition, even when the system frequency bandwidth of a cell where the mobile station device 1 is located changes, the present embodiment measures the RSSI using IQ reception data downsampled to a common sampling rate RC. Therefore, RSSI calculation with respect to different system frequency bandwidths using a common calculation circuit reduces the circuit size by a commonalized circuit, and as a result, current consumption is reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A reception quality measurement device comprising:
a rate changing unit configured to downsample at least either a first sample sequence of a received signal with a first sampling rate or a second sample sequence of the received signal having a second sampling rate to adjust sampling rates of the first sample sequence and the second sample sequence to a common sampling rate; and
a power calculation unit configured to calculate a power intensity according to a cumulative total power of a predetermined number of samples included in either the first sample sequence or the second sample sequence with the common sampling rate.

2. The reception quality measurement device according to claim 1, wherein the power calculation unit calculates the power intensity according to the cumulative total power of a predetermined number of samples included in a sample sequence downsampled by the rate changing unit.

3. The reception quality measurement device according to claim 1, further comprising:
a path search unit configured to detect a path timing of the received signal;
a first timing determination unit configured to determine a plurality of candidates for a second path timing after a first path timing, based on the first path timing detected by the path search unit prior to reception of the received signal, the power intensity of the received signal calculated by the power calculation unit; and
a power memory unit configured to store the power intensity output from the power calculation unit at a timing according to each of the plurality of candidates for the second path timing, wherein
the power calculation unit sequentially outputs a power intensity according to a moving cumulative total of powers of a predetermined number of samples.

4. The reception quality measurement device according to claim 3, further comprising a second timing determination unit configured to determine a read timing of the power intensity stored in the power memory unit before detecting the second path timing, based on the second path timing detected by the path search unit.

5. The reception quality measurement device according to claim 1, further comprising:
a power memory unit configured to store the power intensity output from the power calculation unit; and
a timing determination unit configured to determine a timing for storing the power intensity output from the power calculation unit in the power memory unit, based on a path timing detected by a path search unit prior to reception of the received signal, the power intensity of the received signal calculated by the power calculation unit;
wherein the power calculation unit calculates the power intensity according to a cumulative total power of the predetermined number of samples determined according to an allowable variation width of the path timing.

6. A reception quality measurement method comprising:
downsampling at least either a first sample sequence of a received signal with a first sampling rate or a second sample sequence of the received signal having a second sampling rate to adjust sampling rates of the first sample sequence and the second sample sequence to a common sampling rate; and
calculating a power intensity according to a cumulative total power of a predetermined number of samples included in either the first sample sequence or the second sample sequence with the common sampling rate.

7. The reception quality measurement method according to claim 6, wherein the calculating comprising calculating a power intensity according to a cumulative total power of a predetermined number of samples included in a sample sequence downsampled by the downsampling with the common sampling rate.
